(19) United States
(12) Patent Application Publication
(10) Pub. No.: US 2010/0181260 A1
(43) Pub. Date: Jul. 22, 2010

(54) Method and Apparatus for Water Treatment to Eliminate Aquatic Organisms

(75) Inventor: Ian D. Vroom, Western Cape (ZA)

Correspondence Address: SCHWEGMAN, LUNDBERG & WOESSNER, P.A., P.O. BOX 2938, MINNEAPOLIS, MN, 55402, US

(73) Assignee: Resource Ballast Technologies (Proprietary) Limited, Western Cape (ZA)

(21) Appl. No.: 12/084,226

(22) PCT Filed: Oct. 27, 2006
(86) PCT No.: PCT/IB2006/003022

§ 371 Date: Mar. 19, 2010

(30) Foreign Application Priority Data
Oct. 28, 2005 (ZA) 2005/10473

(51) Int. Cl. C02F 1/36; C02F 1/78; C02F 1/467; B63B 13/00

(52) U.S. Cl. 210/748.03; 210/150

(57) ABSTRACT

A method and apparatus for treating water such as ballast water in ships in order to eliminate aquatic organisms in the water. The water is led under pressure through a conduit into a chamber of greater cross-section than that of the conduit so that an abrupt reduction in pressure occurs. Cavitation ensues, leading to the release of dissolved gases. Ultrasonic vibration is generated and is applied to the water, exerting a pounding effect that weakens or destroys the organisms present. Other means may be used to generate further mechanical, electrical, and chemical forces in the water which attack the organisms.

### FIELD OF THE INVENTION

This invention relates to the treatment of water in order to eliminate aquatic organisms present in the water by destroying these organisms or reducing their numbers to the point where they are unviable as colonies. The invention has particular but not exclusive application in the treatment of ballast water carried by ships, which may give rise to undesirable environmental effects when discharged into seas or lakes distant from the sites where the water was taken aboard.

### BACKGROUND TO THE INVENTION

Modern ships generally carry ballast water in tanks within their hulls to balance and stabilise the ship and to promote its maneuverability. As cargo is taken aboard and settles the ship in the water, ballast water is discharged. Likewise, when cargo is off-loaded, ballast water is pumped into the ballast tanks to maintain the desired equilibrium.

It is well known that, because the volumes of water pumped in and out of ships on this basis are large, and because numerous species of organisms inhabit the waters in which ballast water is taken aboard and discharged, there has been a long history of the release into both seawater and fresh water of alien species, often taken from a distant location. These organisms range from minute plankton species to sizeable pelagic fishes, and include various pathogenic bacteria and micro-organisms (protozoa), present at all stages of their breeding cycle. Some of them have few natural predators in the waters in which they arrive, and if they find a suitable food source in these waters they rapidly colonise their new territory and may begin to dominate it. They may thus become a pest and a threat to the stability of the ecology of their new habitat.

The problem is recognised worldwide as a serious threat to the aquatic environment, and the International Maritime Organisation concluded a treaty in February 2004 which will have the effect of requiring ship-owners to take rigorous and systematic steps to sterilise the ballast water in their vessels. The treaty is in the course of ratification, and concrete provisions regarding the technologies to be applied in implementing it are still under consideration.

Considerable inventive activity has been devoted, particularly in recent years, to potential solutions of the problem. Mainly this has taken the form of chemical treatment of the water in order to kill the organisms which inhabit it. The introduction of chemicals is, however, not in principle a desirable solution since the chemicals may contaminate the waters into which ballast water is discharged, or lead to other harmful side-effects. In some cases the use of toxic chemicals may create a greater problem that that which they are intended to solve.

To mitigate the effects of releasing powerful chemicals into the waters of harbours and anchorages, it has been proposed that chemicals with a transient existence in water should be used, such as ozone. Ozone has a half-life in sea water of only some minutes, and its introduction into ballast water as a sterilising agent has been proposed in U.S. Pat. Nos. 6,125,778 (Rodden), 6,516,738 (Cannon), and application no. 20040055966 (Nguyen et al).

Other inventors have contemplated a sequence of de-oxygenation of the water, to create conditions in which living organisms tend to die, followed by re-oxygenation, to restore the water to an acceptable quality in terms of various standards for it to be discharged (see for example U.S. Pat. No. 5,932,112 (Browning)). The last-mentioned patent also discloses the concept of initial hyper-oxygenation of the water. As oxygen alone, brought into proximity with many living organisms has a biocidal effect because of its oxidising properties, this type of process has merit. Optimal effects are however only obtained under controlled conditions of pressure, temperature, and other factors, and the rate of elimination of aquatic organisms is problematic. Its application is thus not free from technical difficulties, and requires considerable monitoring and supervision.

Several other forms of treatment have been proposed, including the use of filtration and ultra-violet radiation (US patent application 20040055966 of Nguyen et al), heating (U.S. Pat. No. 5,816,181 of Sherman)), and combinations of two or more forms of treatment, such as filtration by centrifugal separation, coupled with exposure to ultra-violet radiation or biocidal chemicals (U.S. Pat. No. 6,500,345 of Constantine et al).

Most of these processes have the disadvantage of requiring either a lengthy or relatively complex process to be used, often in circumstances in which extensive monitoring is necessary.

A somewhat different course is taken in U.S. Pat. No. 6,402,965 (Sullivan et al), which discloses the exposure of ballast water to ultrasonic radiation, on the basis that it is lethal to aquatic organisms, using equipment incorporating a tube lined with a piezo-electric material which acts as a transponder to generate appropriate frequencies. The water passes through this tube. Some interference effects generated by this equipment which tend to destroy organisms in the water are also described. Ultrasonic radiation as a means of destroying aquatic organisms is also mentioned in an influential report, Full-Scale Design Studies of Ballast Water Treatment Systems, prepared for the Great Lakes Ballast Technology Demonstration Project of Northeast-Midwest Institute, Washington, D.C. and the Lake Carriers Association (Glosten-Herbert Hyde Marine, 2002), but no procedures for applying ultrasonic radiation are disclosed.

The fact that ultrasound radiation destroys some living organisms has been known for many years, and its use for this purpose has been described in literature such as Ultrasonic Disintegration as a Method of Extracting Bacterial Enzymes, by P. K. Stumpf, D. E. Green, and F. W. Smith Jr, published in J. Bacteriology 51(4) 487-493 (1946), reproduced in Microbial Interaction with the Physical Environment, ed. D. W. Thayer, Dowden, Hutchinson & Ross, Inc., Stroudburg, Pa., 1975, pp. 405-493. The last-mentioned publication also contains an article in which a tentative explanation for the lethal effect of ultrasonic radiation on protozoa and other organisms was put forward, namely that rupture of the plasma membrane by a chemical or a physical-chemical effect produced by cavitation associated with the ultrasonic radiation in the water immediately surrounding the cell. (See pp. 402-404, article by F. O. Schmitt and B. Uhlemeyer, reprinted from Proc. Soc. Exptl. Biol. Med., 27(7), 626-628 (1930). This article mentions the discovery that the lethal effect could be traced to the cavitation of dissolved gas, reported by C. H. Johnson in J. Physiol., 1929, Ixvii, 365. Further comment on the phenomenon of cavitation is contained in the editor's comments on pp. 370-373 of Microbial Interaction with the Physical Environment.

The use of ultrasonic radiation for water treatment is inherently attractive since it does not depend on the introduction of extraneous chemicals into the water and, when deployed at appropriate amplitudes, appears to have, from the applicant's experience, a powerful effect in killing or weakening organisms of the kind present in seawater and navigable fresh water. It has, however, the disadvantage that standard methods of generating it and monitoring it are relatively complex and the associated equipment is, in the context of shipboard life, relatively fragile.

Accordingly it is an object of the invention to provide a method and apparatus for generating ultrasonic radiation to which water containing harmful organisms, such as the ballast water of ships, can be exposed in order to eliminate these organisms from the water, the method being relatively simple and the associated equipment being relatively robust.

A further object is to provide a method and apparatus by which at least one abrupt change in pressure in ballast water can be brought about, and preferably a plurality of such abrupt changes in pressure, this also having the effect of killing or weakening such organisms.

Another object is to provide a method and apparatus by which, using relatively simple electrical equipment, electro-chemical forces can be generated in water from which aquatic organisms are to be eliminated, these forces having the effect of releasing at least one gas which is harmful to the organisms in question, the gas then being mixed with the water so that surface contact between the gas and the water is enhanced.

### BRIEF DESCRIPTION OF THE INVENTION

According to the invention, a method of treating water containing aquatic organisms in order to destroy the organisms comprises leading the water under pressure through a conduit into a chamber of greater cross-section than that of the conduit, so that the water pressure is abruptly reduced and cavitation takes place, and, with the cavitation, ultrasonic vibration is generated, the ultrasonic vibration and cavitation then acting upon the water.

The water may be the ballast water of a ship.

The chamber and its associated spaces and conduits preferably form part of a reactor through which the water is pumped. If the water is the ballast water of a ship, the method is preferably applied when the water is taken into ballast rather than when the water is discharged.

The conduit leading to the chamber preferably comprises has a first zone of generally constant cross-section through which the water is led under pressure, followed by a zone which reduces progressively in cross-section before debouching into the chamber of increased cross-section, where cavitation occurs. The pressure in the water thus increases as it enters the zone of decreasing cross-section, only to decrease abruptly when the water enters the chamber where cavitation occurs. This effect enhances the extent of the cavitation which would occur if the conduit leading into the chamber were of constant cross-section throughout its length.

With cavitation, vibration of the surrounding structure tends to occur at frequencies which comprise or include an ultrasonic component. If cavitation takes place in components made from mild steel or other common metals, the effect is to cause pitting of the metal. Pitting is reduced to a greater or lesser extent if the components are made of certain grades of stainless steel. In the method and apparatus of the invention pitting is avoided by using stainless steel and lining the relevant components with a known ceramic or other material which eliminates or greatly reduces the extent of pitting. Several compositions with this characteristic are available commercially. Alternatively, a special metal can be used which is relatively immune to pitting. At least one such metal is commercially available. Details are provided below.

The effect of the abrupt reduction in pressure in the reactor chamber is to draw dissolved gases out of the water into the gaseous phase, and ultrasonic vibration occurs in the environment of collapsing bubbles of gas. This leads to intense mechanical agitation in the water. The effect of this agitation, coupled with the chemical effect of the gases as they act upon the surfaces of aquatic organisms, is to kill or weaken the organisms.

The lethal effect of the ultrasonic vibration on aquatic organisms is enhanced, according to the invention, by applying electrical power to electrodes exposed in the water, thereby leading to electrolysis in which dissolved salts in the water, sodium and bromium chloride among them, in the case of sea water, act as the electrolyte. This generates gases which are also subjected to vibration as a result of the ultrasonic radiation, and contributes under these conditions to the destruction of the aquatic organisms. Since some species of aquatic organism are vulnerable to electrical forces of even moderate strength exerted in water, the existence of an electrical charge in the water in the vicinity of the electrodes is another factor tending to destroy the aquatic organisms.

Chlorine and bromine, as well as oxygen and hydrogen, are among the gases released in seawater by electrolytic forces. Chlorine and bromine have a particularly toxic effect on aquatic organisms with which they make contact in the reactor.

The presence of substantial quantities of chlorine and other halide gases or other corrosive gases is not desirable in ballast water that is pumped aboard or discharged from the ballast tanks of a ship, since they tend to corrode the ballast tanks and metal conduits associated with them. Accordingly, the invention provides that these corrosive gases be exposed, within or immediately downstream of the reactor chamber, to metal surfaces with which the gases readily react. Provision should therefore be made for these sacrificial metal components to be replaced regularly.

The invention also contemplates that a suitable gas be introduced into the water within or nearby, and preferably downstream of, the reactor chamber, to further enhance the mechanical, electrical, and chemical processes which occur in the reactor and which have a destructive effect of the aquatic organisms present in the water. Ozone is such a suitable gas, partly because of its strongly oxidising effect on making contact living tissue, thus contributing to the destruction of aquatic organisms which it encounters, and partly because it rapidly breaks down into a gas normally present in the atmosphere, namely oxygen, which is environmentally harmless.

The effectiveness of the method is enhanced by causing the water to be mechanically mixed or stirred in the reactor chamber and associated conduits. This can be achieved by locating suitably spaced and inclined vanes in the inlet and outlet conduits leading into and out of the reactor chamber, and/or in the reactor chamber itself. An effective form of mixing is helical swirling. The vanes may be fixed, so that no maintenance on them is necessary, apart from occasional replacement when they have become worn.

The method of the invention may be enhanced by monitoring the status of various variables that are relevant to its efficiency, including the temperature in the conduits and reaction chamber, the degree of salinity, the pressure at various points in the course followed by the water, and the voltage and current across the electrodes. According to the invention, provision is made for altering such parameters from time to time to optimise the results of the method.

In a preferred form of the invention, the process of increasing the pressure of the water and then abruptly de-pressurising to induce cavitation, and hence ultrasonic radiation, is repeated at least once in quick succession.

Apparatus according to the invention comprises a reactor formed by a housing defining a chamber, a conduit of lesser cross-section than that of the chamber and leading into the chamber, an outlet conduit from the chamber of lesser cross-section than that of the chamber, and means to pump water under pressure into the inlet conduit and hence through the reactor. The inlet conduit preferably may include a terminal portion which decreases progressively in cross-section as it approaches the chamber.

Electrodes to bring about electrolysis in water passing through the apparatus may be contained in the reactor, preferably located within the reactor chamber and fixed within its housing,

Sacrificial electrodes may be located in or nearby the outlet conduit to neutralise corrosive gases by converting them to salts of metals contained in the electrodes.

Vanes to mix the contents of the reactor may be located at suitable points within its interior. The vanes are preferably designed to impart a swirling action to water passing through the reactor.

The apparatus may also include means to introduce one or more gases, such as ozone, from the exterior into the reactor. Means to prevent backflow of such gases may also be provided.

In a preferred form, suitable for use on a ship to treat its ballast water, the apparatus includes a multiple-stage reactor having at least two reactor chambers and inlet conduits, connected in series.

Monitoring devices to measure or indicate and record the status of various factors such as pressure, temperature, pH, salinity, and water flow rate may be provided. The monitoring apparatus may further include means to determine and record the date, time, and global position at which use of the apparatus occurs, and other factors relevant to the objectives of the water treatment undertaken.

The apparatus for carrying out the invention is relatively simple, with no moving parts, and can easily be retro-fitted to a ship. It can conveniently be located in the main conduit through which ballast water is pumped into or discharged from the ballast tanks.

In a typical shipboard installation the piping through which the ballast pump sends water into the ballast tanks is of 300 mm inner diameter. A two-stage reactor according to the invention, with its inlet and outlet conduits, can be inserted into this piping, taking up only approximately 1500 mm in length and weighing only approximately 200 kg. Its controls can be incorporated in a normal shipboard computer system.

### BRIEF DESCRIPTION OF THE DRAWINGS

In the accompanying drawings:

FIG. 1 is a semi-diagrammatic representation of a water treatment reactor of the invention, installed for shipboard use, and shown with its major control elements. This reactor has twin reaction chambers arranged in tandem.

FIG. 2 is a side view of the reactor of FIG. 1.

FIG. 3 is a side view of the reactor of FIGS. 1 and 2, shown longitudinally sectioned.

FIG. 4 is a perspective view on an enlarged scale of a disc with attached vanes, as contained in the reactor of FIGS. 1-3.

FIG. 5 is a perspective view on an enlarged scale of an alternative reactor to that of FIGS. 1-4, having a single reaction chamber.

### DETAILED DESCRIPTION OF THE ILLUSTRATED EMBODIMENT

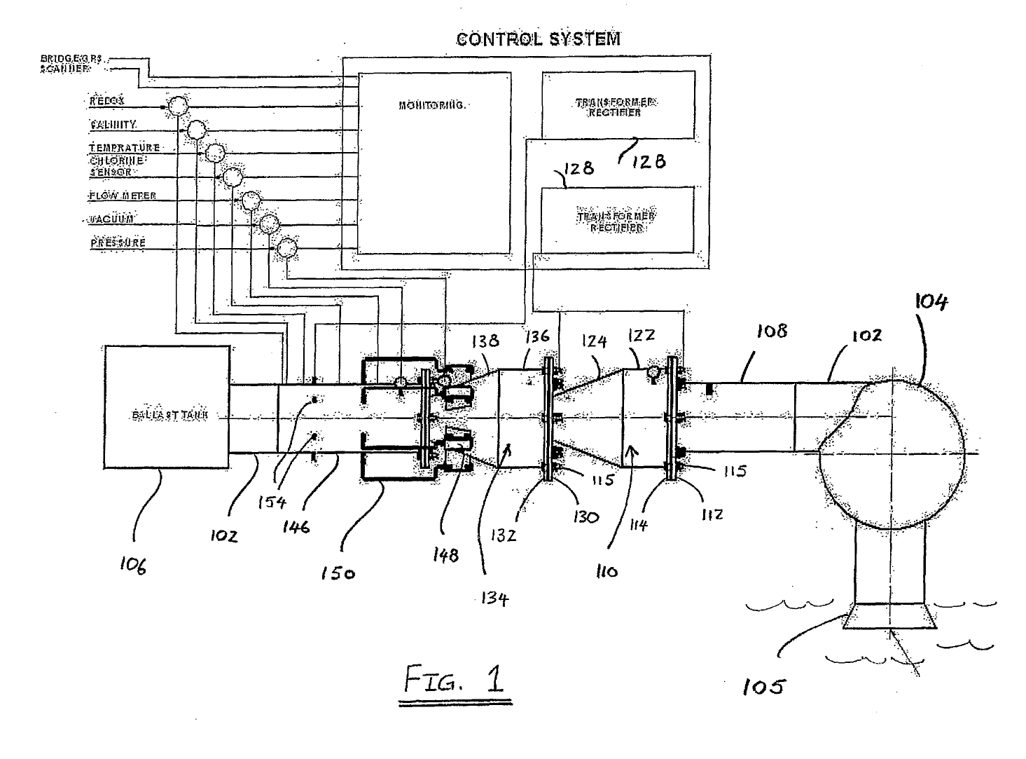

The apparatus illustrated in FIGS. 1-3 is a preferred embodiment of a water treatment apparatus suitable for treating the ballast water of a typical sea-going ship with conventional ballast tanks and a conventional ballast pump.

The apparatus comprises a reactor 100 connected into piping 102 which is of round section and typically of about 300 mm inner diameter. The pipe 102 extends between a ballast pump 104 and one or more ballast tanks 106. The ballast pump 104 draws water from a sea chest 105 for delivery to the ballast tanks.

The operation of the reactor and of processes occurring within it are controlled and monitored by equipment shown in schematic form in FIG. 1.

The reactor comprises (starting from the end nearest the ballast pump 104) an inlet conduit 108 of round section, typically about 300 mm inner diameter, connected by conventional means (not shown) to the piping 102, and a first reactor chamber housing 110 to which the conduit 108 is connected by abutting flanges 112, 114 between which a gasket or O-ring seals (not shown) are located. Similar sealing means are provided between other abutting flanges to be described below. The flanges 112, 114 are secured by bolts 115.

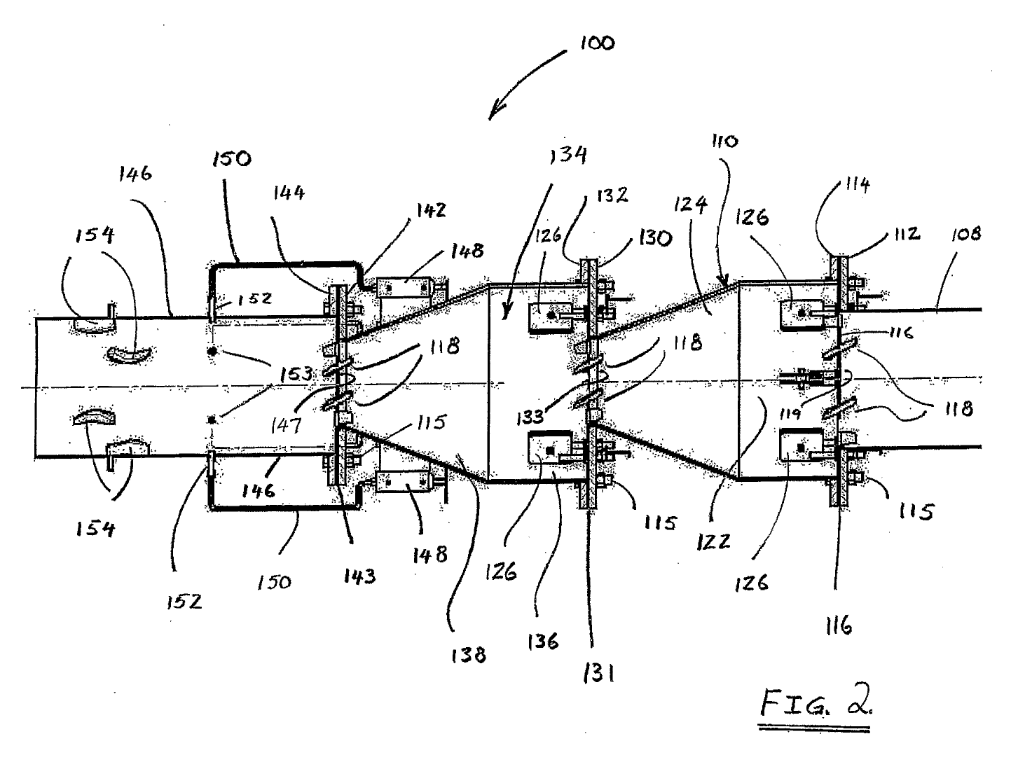

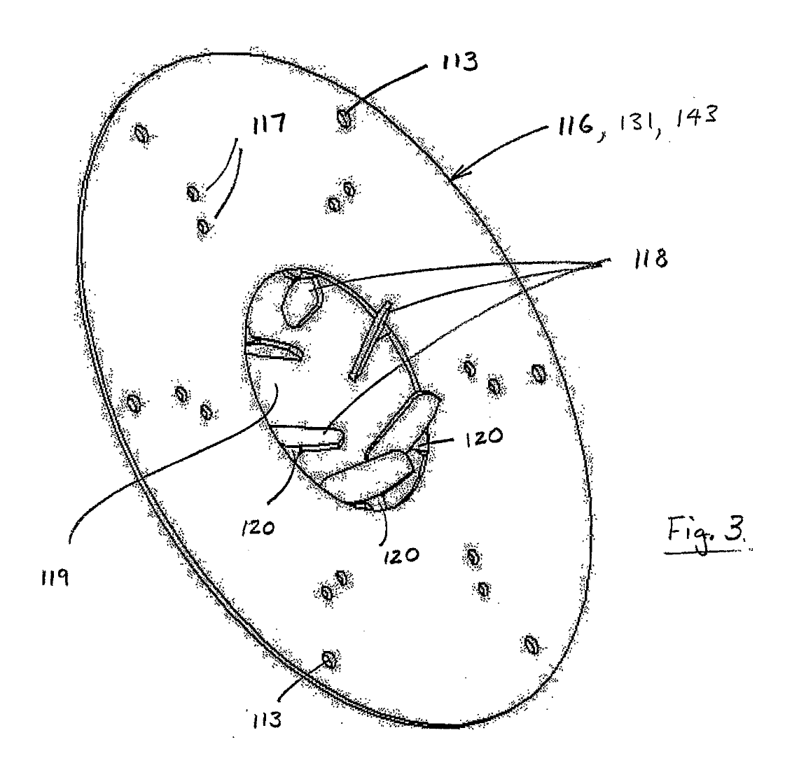

A disc 116 (FIGS. 2 and 3) is mounted between the flanges 112,114 and is sealed between them. The disc 116 comprises an annulus defining an internal space 119, or orifice, with a plurality of vanes 118, preferably about six; extending into the internal space. The vanes are mounted on the inner ends of stalks 120 fixed to the inner circumference of the disc, are bent at an oblique angle to the plane of the disc 116, and are helically bent in their own planes. In use of the apparatus, water pumped through the reactor impinges on the vanes 118 and is deflected by them as it enters the first reactor chamber housing 110. The vanes are so designed that they impart a converging helical swirling action to the water, promoting increased velocity of the water before the water enters a turbulent phase wherein mixing takes place with gases within the reactor.

The disc 116 is provided with circumferentially spaced holes 113 to receive the bolts 115, and also, further towards its centre with spaced pairs of holes 117 into which studs holding the electrodes 126 mentioned below are located.

The first chamber housing 110 has a first zone 122 of constant inner diameter of preferably about 400 mm, that connects directly to the inlet conduit 108, so that there is an abrupt increase in inner diameter in the apparatus as water is pumped from conduit 108 to the first chamber housing 110 by the ballast pump 104. The housing 110 includes a second zone 124 of frusto-conical shape, so that the inner diameter decreases to about 175 mm. The cone angle of this zone is approximately about 20 degrees.

In the first zone 122, the interior of the reactor chamber housing 110 is fitted with three pairs of electrodes 126 (FIG. 2) of a corrosion-resistant metal such as titanium or ruthenium or a composite of them. The electrodes are supplied with 12 V DC or any other appropriate voltage by a transformer-rectifier 128 (FIG. 1). Their function is to cause electrolysis in water passing through the housing 110.

The narrowest part of the frusto-conical zone 124 of the first housing 110 is provided with a flange 130 which is secured by bolts 115 to a corresponding flange 132 of a second reactor chamber housing 134 which, similar to first reactor chamber housing 110, has a first zone 136 of constant inner diameter and a frusto-conical shaped second zone 138. Further electrodes 126 are mounted in the second housing 134, supplied with electrical power. These electrodes similarly cause electrolysis in water passing through the apparatus. An annular disc 131, similar to the disc 116, also equipped with vanes 118 is located and sealed between the flanges 130,132, providing a circular orifice 133 between first chamber housing 110 and second chamber housing 134.

The narrowest part of the frusto-conical zone 138 of the second chamber housing 134 is provided with a flange 142 which abuts a corresponding flange 144 of an exit conduit 146 of similar diameter to inlet conduit 108. The flanges 142, 144 are secured by bolts 115. An annular disc 143, similar to the disc 116, also equipped with vanes 118 is located and sealed between the flanges 142, 144, providing a circular orifice 147 between the second chamber housing 134 and the exit conduit 146.

The end of the exit conduit 146 is connected (by conventional means not shown) to the pipe 102 which leads to the ballast tank 106 (FIG. 1).

In another aspect of the invention, a plurality of ozone generators 148, preferably six, may be fixed to the outer surface of the second housing 134. The ozone generators are of a known type, for instance as described in patent documents PCT/ZA2000/00031 and PCT/ZA2001/00024 and available commercially from Sterizone, P.O. Box 13935, Witfield, Republic of South Africa, 1467. These devices draw air from the atmosphere and, by means of corona discharge, generate ozone in a space where it is captured and fed into a tube 150 into which a one-way valve 152 is installed. The tubes 150 lead into the interior of the reactor at ports 153 spaced circumferentially around the conduit 146.

In yet a further aspect, sacrificial electrodes 154 may be fixed in the interior of the exit conduit 146 near its end, and are shaped as vanes on which water passing through the reactor will impinge. These electrodes 154 are made of a metal such as 70/30 brass (i.e. 70% copper and 30% zinc) which will react with free chlorine and other corrosive gases present in the water, converting the gases to salts such as copper sulphate or copper chloride which are damaging to many species of waterborne organisms. Since the quantity of the relevant gases is relatively very small, having been derived purely from the dissolved gas content of the water pumped aboard, the resultant metal salts are highly diluted and cause no appreciable damage to the structure of the ship. However, they exert a toxic effect on any fishes and many other organisms which may have survived passage through the reactor chambers 110, 134, and hence have a residual sterilising effect on the water.

The power supply to the electrodes 154 is adjusted to ensure that the level of free chlorine in the water on leaving the reactor 100 does not exceed acceptable limits.

The body of the reactor is made from stainless steel of 316 grade, fabricated from sheeting of 4.5 mm thickness.

The whole of the inside surface of the reactor, except the surfaces of the electrodes 126 and the vanes 154, may be coated with a ceramic or resinous or other material which protects the metal of the reactor from pitting. This lining also, in favourable cases, has characteristics which enhance at least some of the processes which occur within the reactor. The mechanisms in question include ion exchange, frictional contact which contributes to the mixing of the gases and water, and piezo-electrical and pyro-electrical effects which contribute to electrical destruction of some organisms. A suitable material for the lining is available commercially as MetaCeram (trademark) 28060, which is a spray-on, aluminium-titanium based, oxygen-stabilised complex compound with specific grain size and controlled morphology. Another is known as Elce (trademark), produced by Nihon Jisui Company Ltd, 78 Gion 3—Chome, Miyazaki City, Japan (e-mail elce@orange.ocn.ne.jp). Others are Belzona (trademark) 5811, available from Belzona Polymerics Ltd, Harrowgate, HG1 4AY, England, and Lewatit (trademark), from Bayer AG of D-51368 Leverkusen, Germany.

The control devices for the reactor are shown in FIG. 1 and include one or more pressure gauges to indicate the pressure at critical points in the reactor and its inlet and outlet conduits, a redox (residual oxygen reduction potential) meter, a salinity meter, one or more temperature gauges, one or more chlorine sensors, vacuum meters at points of abrupt chance in cross-section where sub-atmospheric pressures will be present, and a scanner for importing data to the ship's computer system, and a GPS indicating device and other devices measuring bridge information that is recorded in the computer system. The control devices may also include means to influence some of the processes, e.g potentiometers for the electrical supply to the electrodes, regulating valves for the supply of ozone or other externally provided gas, and other devices known in the field of water treatment.

In a preferred use, the reactor illustrated in FIGS. 1-3 is designed to operate at a flow rate of 400-500 kilolitres/hour, or approximately 150 litres/second, and under a minimum pumphead pressure of 3 bars.

In operation of the reactor 100, the ballast pump 104 is switched on to draw water from an open water body such as the sea, a lake, or a river, into the sea chest 105 and propel it under pressure through the conduit 102 into the reactor 100. This water will likely contain marine organisms native to the area in which the ship is located at the time, some of which may be capable of contributing to environmental damage if the water is discharged elsewhere.

The water passes through the conduit 108, at the end of which it encounters the vanes 118 and is given a helical swirling motion. As the water enters the first zone 122 of the housing 110, the cross-section of the reactor increases abruptly. The water also brushes against the electrodes 126, which are at this stage under power, and electrolytic reactions ensue, leading to the generation of gases, chiefly oxygen, hydrogen, chlorine, and bromine. The swirling action caused by the vanes causes these gases to mix evenly in the water, exposing any organisms to destructive effect. Furthermore, when transmitted through the water in the reaction chamber 100, the electrical charge itself has a destructive effect on the smaller marine organisms.

As the water leaves the first zone 122 and enters the tapered zone 124 of reaction chamber 110, the velocity of the water increases progressively. It will be appreciated by one of ordinary skill that, following the principle of Bernoulli, the increase in water velocity increases the local velocity pressure head in the water, but decreases the local static pressure head. It will be further appreciated that, if the water velocity is caused to increase to a sufficient degree, the static water pressure head will fall below the vaporization pressure of the water. This will effectively cause the water to boil, or “cavitate,” at the point of maximum water velocity. When this happens, small bubbles of vaporized water (mixed with any other gases dissolved in the water such as oxygen, hydrogen, and chlorine) appear, only to collapse again as the bubbles move into an area of higher static pressure head and lower velocity. The collapse of these bubbles in turn may cause high frequency and high energy shock waves (including frequencies in the ultrasonic, i.e., 20,000 hertz range), to travel through the water with the effect of destroying organisms locally present.

However, it will be appreciated that, even if the water is not brought to the point of cavitation, it may be brought to a sub-atmospheric pressure just short of vaporization pressure. Many marine organisms are capable of surviving and even flourishing at considerable depth in water, and thus can resist pressures considerably greater than atmospheric pressure, but they are organically ill-equipped for sub-atmospheric pressures and suffer extreme stress from this cause alone, even without cavitation taking place.

Thus, the size of the orifice 133 between the first reaction chamber 110 and second reaction chamber 134 is selected so that, as the water passes through the orifice 133, its velocity is great enough to cause cavitation to occur in the water downstream of the orifice, or at least, to cause a substantial reduction in pressure below atmospheric pressure. In a preferred embodiment, the vanes 118 positioned at the orifice 133 impart a converging helical twisting motion to the water as it passes into the second chamber 134. This may have the effect of further accelerating the water velocity locally, and further increasing the degree of cavitation, and pressure reduction generally, in the water downstream of the orifice 133.

Accordingly, in the configuration of the preferred embodiment as described, cavitation is purposely induced downstream of the orifice 133, a location where the diameter of the apparatus abruptly increases in moving from first chamber housing 110 to second chamber housing 134. This has the advantage that the energy released by the imploding bubbles will not pass directly into surrounding metal surfaces of the second chamber housing 134 to cause damage. Rather, the energy first has to travel through a substantial body of water before reaching the metal surface of the housing. This configuration allows the sonic energy to substantially dissipate in the water, where it kills the organisms present, before acting on the remote metal surfaces of the second chamber 134. Should ultrasonic energy impact the remote metal surfaces of the chamber 134, the ceramic or other lining of the reactor may act to inhibit pitting or other damage to the metal components of the reactor, and the material of the lining provides the additional effects described above that are associated with its particular composition.

A further feature of the preferred embodiment is that, while passing through the first zone 136, additional electro-chemical forces are released on the organisms by the electrolytic action of the electrodes 126 present in this zone. These destructive effects are enhanced by exposure to the oxidising or otherwise toxic gases present, and by the presence of electrical fields in the water. The helical motion of the water in this zone imparted by vanes 118 advantageously facilitates mixing of the water in the environment of the toxic gases.

In the preferred embodiment, having passed through first zone 136, the water may once again be subjected to increased velocity as it passes along tapered zone 138, and then passes through orifice 147 at a velocity sufficient to cause cavitation downstream of the orifice 147 within the conduit 146. Vanes 118 may similarly be positioned at orifice 147 to induce a converging helical spiral flow. Thus, water flowing through the reactor 100 will encounter at least two locations where its velocity is increased to a point where cavitation occurs to induce high energy ultrasonic vibrations. Any organisms that survive treatment in the second reaction chamber 134 will be exposed to similar treatment downstream of the orifice 147 in the exit conduit 146.

It will be appreciated that additional constrictions and expansions may be placed in the path of the water, to provide a plurality of locations where cavitation may occur. However, it will also be appreciated that each constriction will require additional pump energy to activate the reactor 100, and that if too many constrictions are introduced, the pumping capacity available may be insufficient.

In another aspect of the preferred embodiment, as water passes further down the conduit 146 it may be engaged and mixed with ozone from the ozone generators 148, entering the reactor at the circumferential entry ports 153.

The ozone gas mixes with the water and exerts a powerful oxidising effect, with lethal consequences, on any organisms present in the water with which it makes contact. The water is still in a stage of agitation from the mixing upstream, and the ozone gas is also mixed into the water. Because of its short half-life in seawater, the remaining ozone rapidly breaks down into oxygen, which itself exerts an oxidising and hence destructive effect on the organisms against which it impinges.

In yet a further aspect of the preferred embodiment, the water finally encounters the sacrificial vanes 154, where any free corrosive gases react with the metal of these vanes and are converted to dissolved salts which are of very low concentration but are toxic to certain organisms which may have survived up to this point. The vanes 154 also having a mixing effect on the water, completing the processes of pounding and gas exposure which have characterised earlier stages of the progression of water through the reactor. A residue of chlorine is advantageous to ensure that the ballast water remains sterile.

The consequence of these events is that organisms present in the water taken aboard and passed through the reactor are substantially destroyed by a combination of reactions, so eliminating them from the water and effectively sterilising it. The environmental burden caused by later discharge from the ship will be significantly reduced.

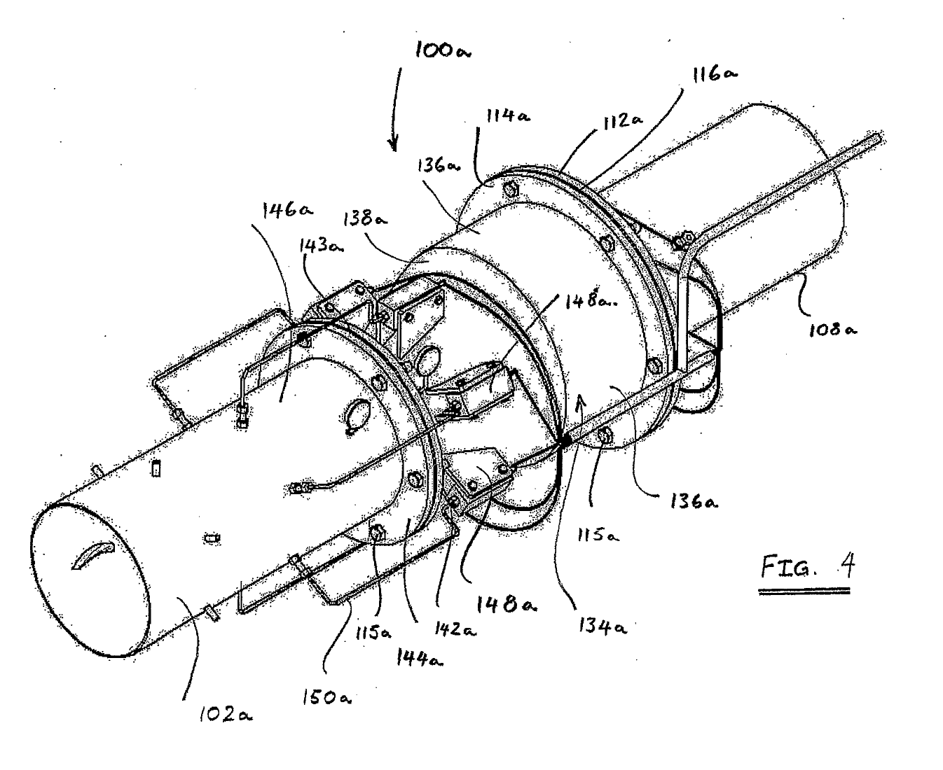

In another preferred embodiment, exemplified in FIG. 4, components corresponding to those of the reactor of FIGS. 1-3 are given corresponding reference numbers together with the suffix a. In this embodiment a single reaction chamber housing 136a, 138a is provided, equipped at its entrance with pairs of electrodes (not visible), and, within its outlet conduit 146a, a set of sacrificial electrodes 154a. In other respects the reactor is generally similar to that of the preceding Figures and is operated similarly to the reactor of the preceding Figures. It will be appreciated that the possibility of aquatic organisms surviving passage through this version, compared to that of the preceding Figures, is necessarily increased. However, it will also be appreciated that less energy will be required to force the water through the reactor which may be desirable in particular cases where smaller pumps are available.

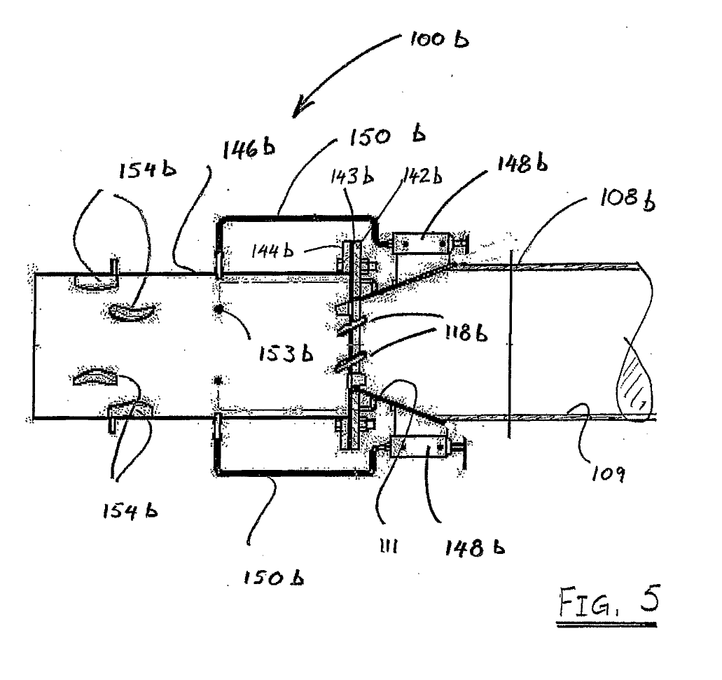

The embodiment exemplified in FIG. 5 is the simplest illustrated. In it, reference numbers corresponding to those of FIG. 2 are reproduced with the suffix b to indicate corresponding components. The inlet conduit 108 b in the embodiment of FIG. 5 has a first part 109 of constant cross-section and a final part 111 of tapered cross-section. The latter part debouches into the inner end of the outlet conduit 146b, with an abrupt increase in cross-section at this point. Vanes 118b are located at the point of entry into the reaction chamber. In this embodiment, no external electrolytic force is added at this point and hence no electrodes are present in the reaction chamber. Sacrificial electrodes 154b are however provided and supplied by a transformer/rectifier that is not illustrated, in order to react with and neutralise any corrosive gases generated by the cavitation which occurs on entry of water into the reaction chamber through the tapered conduit 111 and not consumed by reaction with organisms in the reaction chamber. A supply of ozone or another suitable gas capable of acting on aquatic organisms with lethal effect is supplied through tubes with one-way valves 152b to entry ports 153b spaced around the circumference of the conduit 146b.

Among the advantages of the invention, in relation to water treatment systems of the prior art, are its effectiveness, simplicity, absence of moving parts or externally added toxic substances, light weight and compactness, ease of installation either as original equipment or by retro-fitting, its low maintenance, capacity to operate for lengthy periods without maintenance, safety, and cost-effectiveness.

While the specification describes particular embodiments of the present invention, it will also be apparent to those of ordinary skill that various modifications can be made without departing from the spirit and scope of the invention.

1. A method for reducing aquatic organic contamination present in a volume of water, comprising:
pumping the water from an open body of water contaminated with aquatic organisms through an elongate conduit system, the water having a volumetric flow rate that is the same at all points in the system, and having, at any point in the system, a pressure head and a velocity head; and
directing the water into a ship's ballast tank; and
characterised by pumping the water through a conduit system of varying diameter such that the pressure head in the water is caused to fall to a level below atmospheric pressure at a first point in the system by increasing the velocity head of the water at the first point.

2. The method of claim 1, wherein the water has a vapour pressure below atmospheric pressure, and wherein the pressure head in the water at the first point is caused to fall to a level below the vapor pressure, thereby initiating cavitation in the water at the first point.

3. The method of claim 1, wherein the conduit system has an upstream end and a downstream end, and wherein the first point is situated in the conduit system at a location where the diameter abruptly increases immediately downstream of the first point.

4. The method of claim 1, further comprising giving the water a helical swirling motion at the first point.

5. The method of claim 4, wherein the helical swirling motion is made to be converging.

6. The method of claim 1, further comprising causing the pressure head in the water to fall to a level below atmospheric pressure at a second point in the system by increasing the velocity head of the water at the second point.

7. The method of claim 6, wherein the water has a vapour pressure below atmospheric pressure, and wherein the pressure head at the second point is caused to fall to a level below the vapour pressure, thereby initiating cavitation in the water at the second point.

8. The method of claim 1, further comprising forcing the water to pass over electrodes to which electrical power is applied.

9. The method of claim 8, wherein the electrical power is elevated to a level sufficient to generate debilitating electrical reactions in organisms sensitive to electrical forces.

10. The method of claim 8, wherein the water contains dissolved gasses, further comprising elevating the electrical power to a level sufficient to cause some of the dissolved gases to effervesce.

11. The method of claim 1, further comprising causing the water to pass over a plurality of electrodes of a metal which reacts with corrosive gases, and applying electrical power to such electrodes sufficient to cause neutralization of the gases by reaction with the material of such electrodes.

12. The method of claim further comprising introducing a gas under pressure into the water.

13. The method of claim 12 in which the gas is one of the group consisting of ozone, carbon dioxide and exhaust gas.

14. The method of claim 1, wherein the conduit system includes a removable annular disc defining an orifice, further comprising removing the annular disc from the conduit system, and replacing it with a substitute annular disc.

15. The method of claim 14, wherein the annular disc is formed of stainless steel.

16. The method of claim 14, wherein the annular disc is formed of a ceramic material.

17. An apparatus for reducing aquatic organisms in a body of water, comprising: an elongate conduit system having an upstream end and a downstream end, and being configured to permit the water to flow therein at a constant volumetric rate, characterised in the conduit system defining portions that comprise: a first tapered portion having a generally frusto-conical shape, and having a downstream end defining a first opening having a first diameter, and an upstream end defining a second opening having a second diameter larger than the first diameter; and a first reactor portion having a generally cylindrical shape with a third diameter, larger than the first diameter, the first reactor portion being connected to the downstream end of the first tapered portion by a radially disposed connector, such that the diameter of the conduit system immediately increases abruptly downstream of the first opening in the tapered portion; wherein the first diameter is sized to initiate cavitation in water flowing downstream through the conduit system.

18. The apparatus of claim 17, further comprising an annular disc defining an orifice having a diameter smaller than the first diameter, the disc being adapted to be inserted and removed, by bolting and unbolting respectively, from a position between the first tapered portion and the first reactor portion.

19. The apparatus of claim 18, wherein the disc is made of stainless steel.

20. The apparatus of claim 18, wherein the disc is made of ceramic material.

21. The apparatus of claim 17 in which the interior of the reactor portion is lined with a material which reduces damage by pitting.

22. The apparatus of claim 18 further comprising means for imparting a helical flow to water passing through the first opening.

23. The apparatus of claim 17 further comprising vanes configured to impart a helical flow to water passing through the first opening.

24. The apparatus of claim 23 in which the vanes are fixed and are inclined in a helical path.

25. The apparatus of claim 17 further comprising at least one pair of electrodes located within the conduit system configured to induce an electric current in water flowing within the conduit system.

26. The apparatus of claim 17 further comprising ports adapted to introduce an external gas into the water.

27. The apparatus of claim 25 wherein the electrodes are formed of a material which reacts with minerals dissolved in the water so as to form corrosive gases.

28. The apparatus of claim 17 wherein the conduit defines portions that further comprise: a second tapered portion having a generally frusta-conical shape, and having a downstream end defining a third opening having a third diameter, and an upstream end defining a fourth opening having a fourth diameter larger than the third diameter; a second reactor portion having a generally cylindrical shape with a fifth diameter, larger than the third diameter, the second reactor portion being connected to downstream end of the second tapered portion by a radially disposed connector, such that the diameter of the conduit system immediately increases abruptly downstream of the third opening in the second tapered portion; wherein the second tapered portion is connected to the first reactor portion, and the third diameter is sized to initiate cavitation in water flowing through of the conduit system.
